(19) United States
(12) Patent Application Publication
(10) Pub. No.: US 2022/0026880 A1
(43) Pub. Date: Jan. 27, 2022

(54) SYSTEM AND METHOD FOR SERVICE LIFE MANAGEMENT BASED ON HUMIDITY CONTROL

(71) Applicant: Dell Products L.P., Hopkinton, MA (US)

(72) Inventors: Steven Embleton, Austin, TX (US); Jon Taylor Fitch, Austin, TX (US); Sandor T. Farkas, Round Rock, TX (US); Joseph Danny King, Georgetown, TX (US)

(21) Appl. No.: 16/938,558

(22) Filed: Jul. 24, 2020

(51) Int. Cl. G05B 19/4155

(52) U.S. Cl. CPC G05B 19/4155; G05B 2219/37375

(57) ABSTRACT

A computing device of an information handling system includes a computing component associated with a risk of corrosion and a corrosion management component. The corrosion management components releases humidity into an environment associated with the computing component while the risk of corrosion due to the environment is a low risk of corrosion, and absorbs humidity from the environment associated with the computing component while the risk of corrosion due to the environment is a high risk of corrosion.

### BACKGROUND

As the value and use of information continues to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Use cases for information handling systems are causing progressively larger number of information handling systems to be disposed near each other. For example, rack mount systems utilize a rack structure to stack many information handling systems in a vertical arrangement. Due to the changing uses of information handling systems, chassis of information handling systems may modular. That is, a chassis may be composed of multiple enclosures that may be attached to each other to form the chassis of the information handling systems. When the multiple enclosures are attached, components of the information handling system disposed in each of the enclosures may become operably connected to each other.

### SUMMARY

In one aspect, a computing device of an information handling system in accordance with one or more embodiments of the invention includes a computing component associated with a risk of corrosion; and a corrosion management component. The corrosion management components releases humidity into an environment associated with the computing component while the risk of corrosion due to the environment is a low risk of corrosion, and absorbs humidity from the environment associated with the computing component while the risk of corrosion due to the environment is a high risk of corrosion.

In one aspect, a method for environmentally managing a computing device of an information handling system in accordance with one or more embodiments of the invention includes monitoring environmental conditions associated with a computing component of the computing device; while the environmental conditions indicate that a risk of corrosion of the computing component is low, increasing the risk of corrosion by heating a corrosion management component; and while the environmental conditions indicate that the risk of corrosion is not low, decreasing the risk of corrosion by absorbing humidity using the corrosion management component.

In one aspect, a non-transitory computer readable medium includes computer readable program code, which when executed by a computer processor enables the computer processor to perform a method for environmentally managing a computing device of an information handling system, the method includes monitoring environmental conditions associated with a computing component of the computing device; while the environmental conditions indicate that a risk of corrosion of the computing component is low, increasing the risk of corrosion by heating a corrosion management component; and while the environmental conditions indicate that the risk of corrosion is not low, decreasing the risk of corrosion by absorbing humidity using the corrosion management component.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of an information handling system in accordance with one or more embodiments of the invention.

FIG. 1.2 shows a diagram of a building that includes information handling systems in accordance with one or more embodiments of the invention.

FIG. 1.3 shows a diagram of a chassis of an information handling systems in accordance with one or more embodiments of the invention.

FIG. 1.4 shows a diagram of computing components integrated with corrosion management components in accordance with one or more embodiments of the invention.

FIG. 1.5 shows a side view diagram of a circuit card integrated corrosion management component in accordance with one or more embodiments of the invention.

FIG. 1.6 shows a side view diagram of a corrosion management material in accordance with one or more embodiments of the invention.

FIG. 1.7 shows a side view diagram of a surface deposited corrosion management material in accordance with one or more embodiments of the invention.

FIG. 1.8 shows a tope view diagram of a chassis that includes corrosion management components in accordance with one or more embodiments of the invention.

FIG. 2 shows a diagram of an environmental manager of an information handling system in accordance with one or more embodiments of the invention.

FIG. 3 shows a flowchart of a method of managing corrosion in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for managing components of an information handling system. An information handling system may be a system that provides computer implemented services. These services may include, for example, database services, electronic communication services, data storage services, etc.

To provide these services, the information handling system may include one or more computing devices. The computing devices may include any number of computing components that facilitate providing of the services of the information handling system. The computing components may include, for example, processors, memory modules, circuit cards that interconnect these components, etc.

During operation, these components may generate heat and require gas flows (e.g., for cooling purposes) to maintain the temperatures of these components within nominal ranges. The gases may be received through air exchanges of chassis in which the components are disposed. However, these gases may not be benign. They may include humidity or other chemical species that cause components to corrode. The corrosion may damage the corroded components thereby causing the components or an IHS to prematurely fail ahead of its desired service life.

Embodiments of the invention may provide methods and systems that manage corrosion. To manage the corrosion, corrosion management components may be used to modify environmental conditions to reduce the rates of corrosion. For example, the corrosion management components may absorb humidity. By absorbing humidity, the relative humidity level of the environment proximate to components subject to corrosion may be reduced. By reducing the relative humidity level, the corrosion rates of the components may be reduced to levels that enable the components and/or IHS incorporating the components from prematurely failing due to corrosion.

Consequently, a system in accordance with embodiments of the invention may be less likely to prematurely fail or otherwise enter an undesirable corrosion state due to corrosion, be more likely to meet its service life goal, be able to accept a wider range of intake gas conditions (e.g., higher humidity) that may be more likely to cause corrosion without negatively impacting the system, and/or may be less costly to operate by reducing the necessary level of conditioning of gases taken into the chassis of information handling systems for cooling purposes.

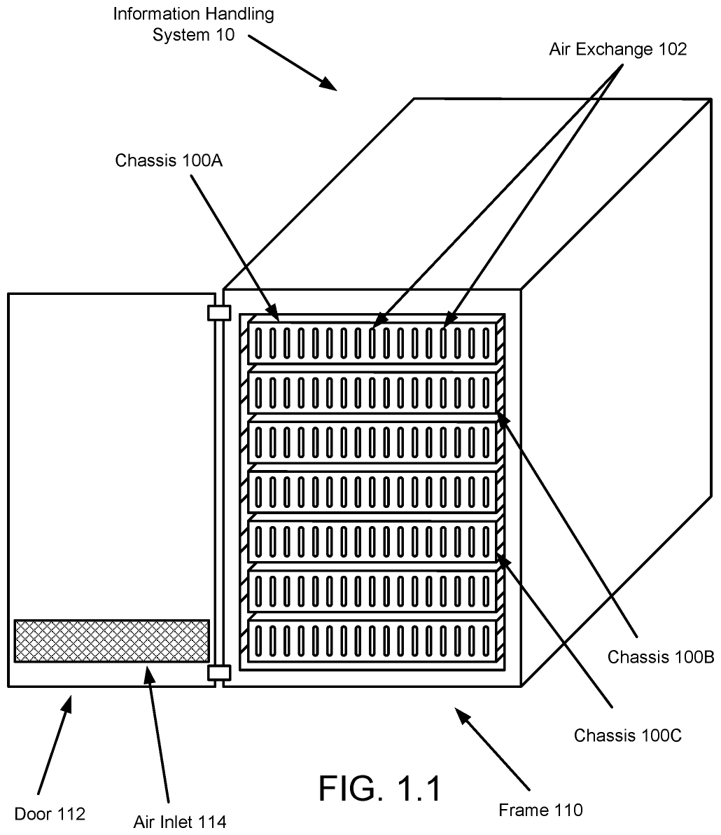

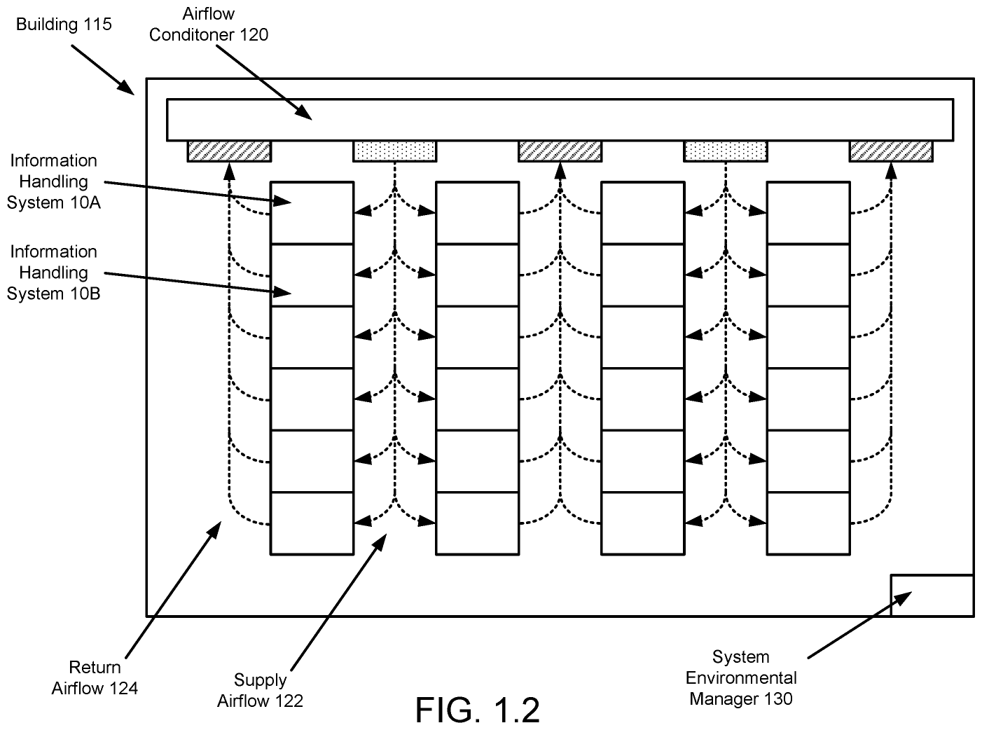

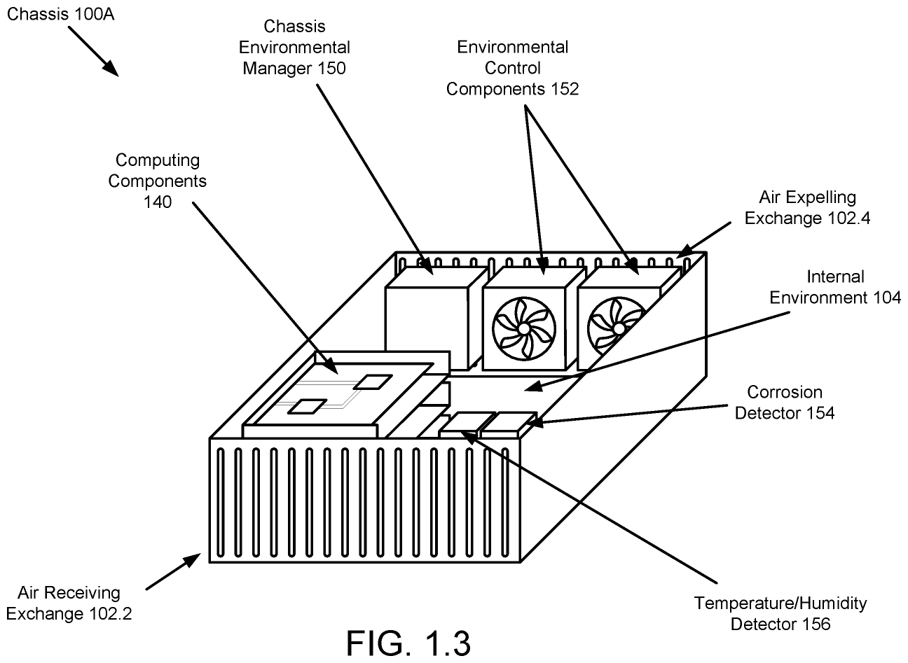

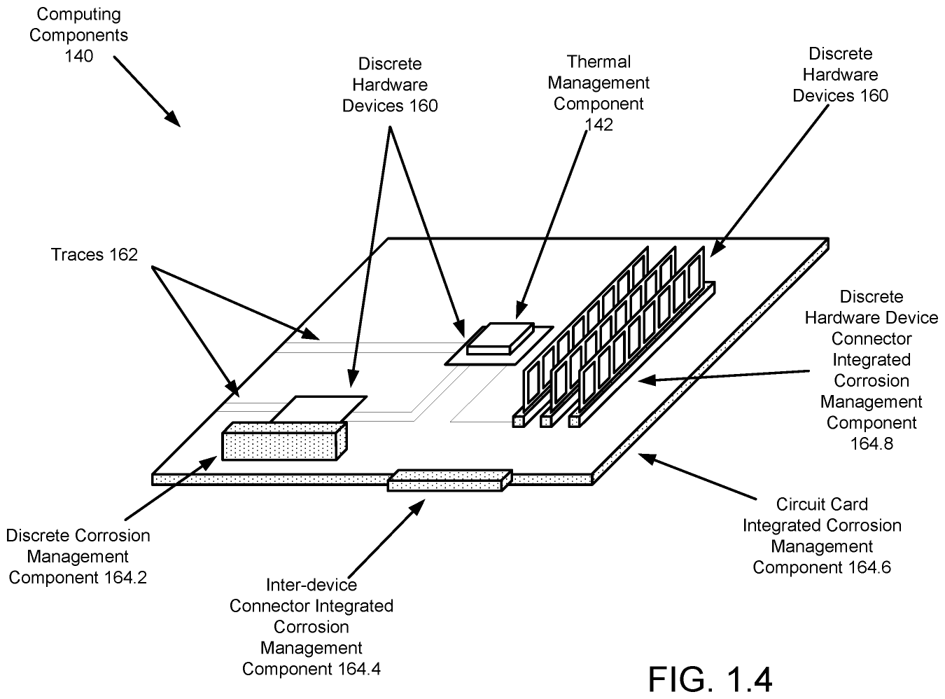

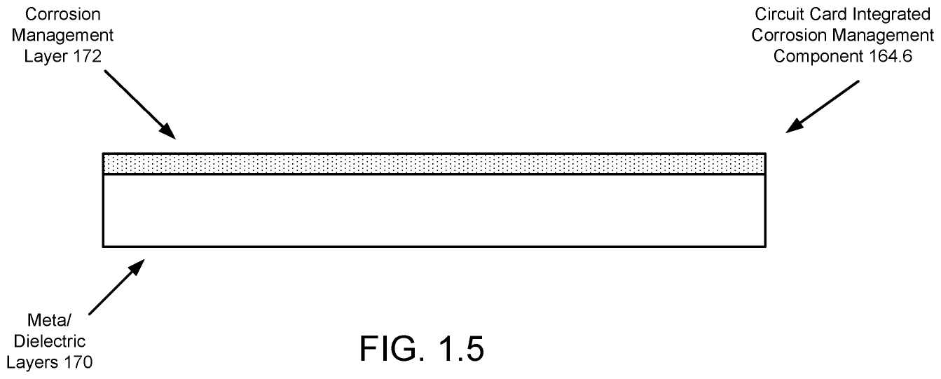

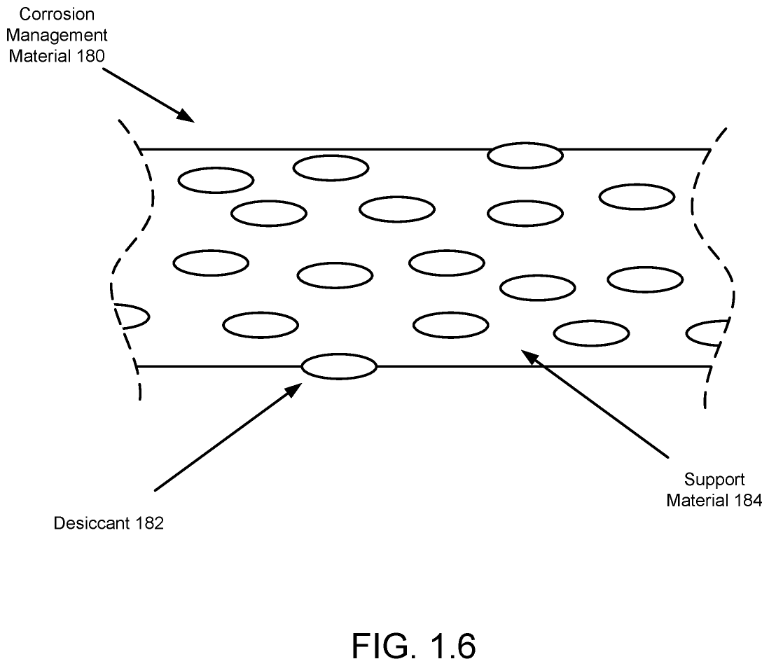

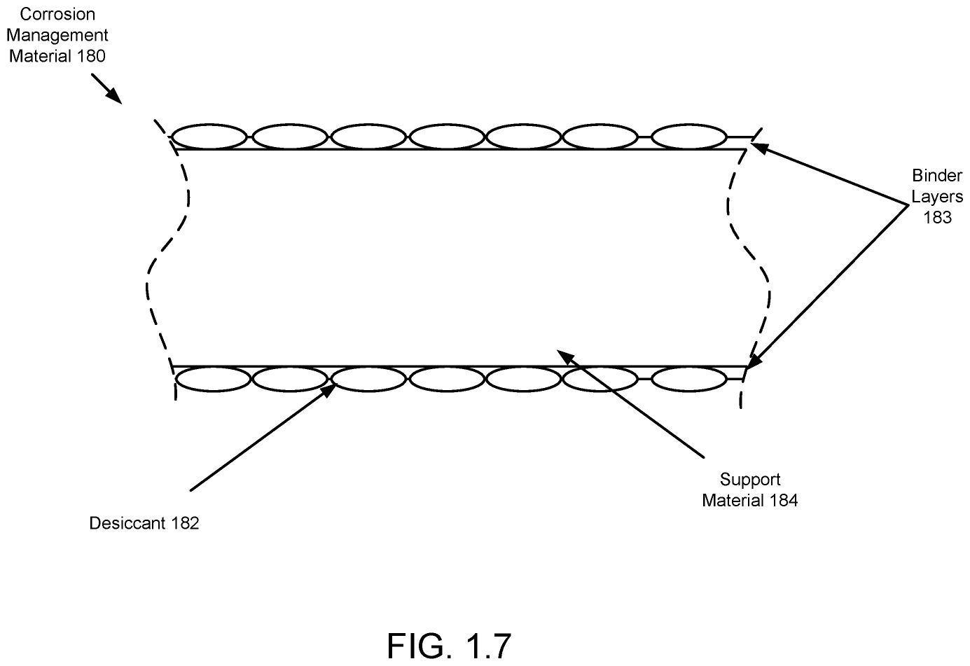

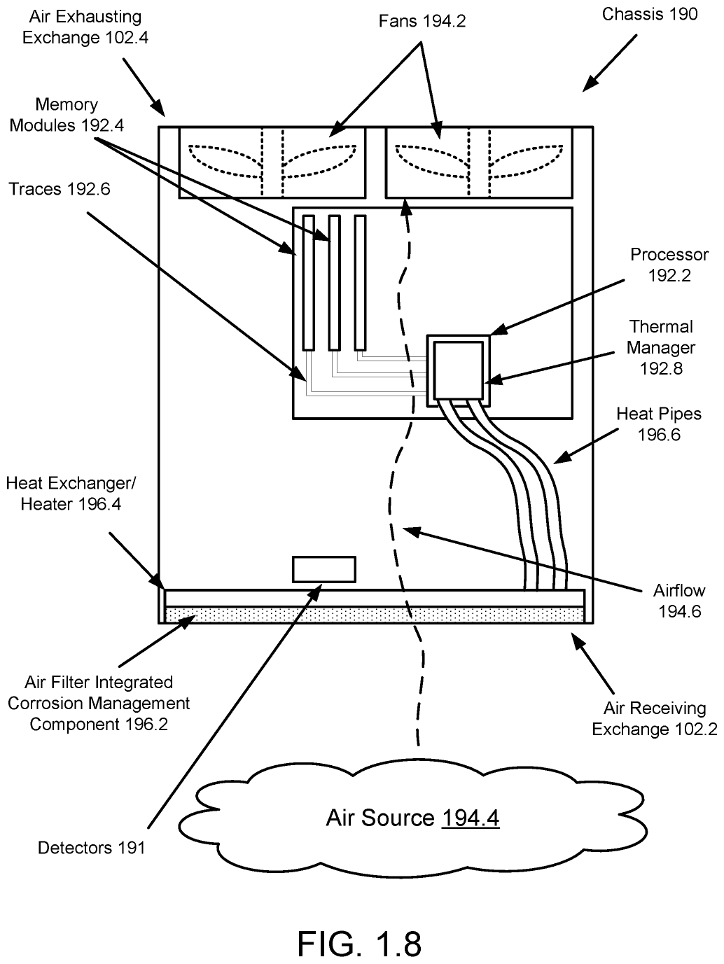

FIG. 1.1 shows an information handling system (10) in accordance with one or more embodiments of the invention. The system may include a frame (110) and any number of chassis (e.g., 100A, 100B, 100C).

The frame (110) may be a mechanical structure that enables chassis to be positioned with respect to one another. For example, the frame (110) may be a rack mount enclosure that enables chassis to be disposed within it. The frame (110) may be implemented as other types of structures adapted to house, position, orient, and/or otherwise physically, mechanically, electrically, and/or thermally manage chassis. By managing the chassis, the frame (110) may enable multiple chassis to be densely packed in space without negatively impacting the operation of the information handling system (10).

A chassis (e.g., 100A) may be a mechanical structure for housing components of an information handling system. For example, a chassis may be implemented as a rack mountable enclosure for housing components of an information handling system. The chassis may be adapted to be disposed within the frame (110) and/or utilize services provided by the frame (110) and/or other devices. Chassis may be of any form factor (e.g., 1U, 2U, 4U, etc.) without departing from the invention.

Any number of components (e.g., computing components, mechanical devices, electrical devices, etc.) may be disposed in each of the respective chassis (e.g., 100A, 100B, 100C). These components may be portions of computing devices that provide computer implemented services, discussed in greater detail below. These services may form the functionality of an IHS.

When the components provide computer implemented services, the components may generate heat. For example, the components may utilize electrical energy to perform computations and generate heat as a byproduct of performing the computations. If left unchecked, buildup of heat within a chassis may cause temperatures of the components disposed within the chassis to exceed preferred ranges.

The preferred ranges may include a nominal range in which the components respectively operate (i) without detriment and/or (ii) are likely to be able to continue to operate through a predetermined service life of a component. Consequently, it may be desirable to maintain the temperatures of the respective components within the preferred range (e.g., a nominal range).

When a component operates outside of the preferred range, the service life of the component may be reduced, the component may not be able to perform optimally (e.g., reduced ability to provide computations, higher likelihood of error introduced into computations, etc.), and/or the component may be more likely to unexpectedly fail. The component may be subject to other undesirable behavior when operating outside of the preferred range without departing from the invention.

To operate components within the preferred range of temperature, the chassis may include air exchanges (e.g., 102). An air exchange may be one or more openings in an exterior of a chassis that enables the chassis to exchange gases with an ambient environment. For example, a chassis may utilize air exchanges to (i) vent hot gases and (ii) intake cool gases. By doing so, the temperature of the gases within the chassis may be reduced. Consequently, the temperatures of components within the chassis may be reduced by utilizing the cooler gases taken into the chassis via an air exchange.

However, utilizing gases to cool components within a chassis may be problematic. The gases may not be benign. For example, the gases may be (i) chemically reactive, (ii) include humidity, and/or (iii) otherwise interact with portions of the chassis and/or components disposed within the chassis in an undesirable manner. The reaction between the gases used to cool the components and the components themselves (or other components proximate to the to-be-cooled components) may negatively impact the components disposed within the chassis and/or the chassis.

For example, if the gases include a chemically reactive component (e.g., chlorine species), the gases may react (i.e., chemically react) with portions of the chassis and/or components disposed within the chassis. These reactions may (i) generate corrosion on the portions of the chassis and/or (ii) generate corrosion on the components disposed within the chasses. This corrosion may damage portions of the components disposed within the chassis directly resulting in a decreased service life of the components.

In another example, if the gases include humidity, the humidity may (under certain conditions) condense resulting in water (even at low levels) being disposed on the surfaces of the chassis and/or components. For example, when gases are taken into the chassis via an air exchange (102), water vapor may condense onto the surfaces of the components if the environmental conditions cause condensation to form.

When water is disposed on the surface of the chassis and/or components (even at very small levels), the water may chemically react forming corrosion. The aforementioned reactions with the condensed water may generate corrosion products that may damage (e.g., change their electrical and/or physical properties) the components or otherwise cause them to operate in an undesirable manner.

The aforementioned reactions may cause other negative impacts beyond those discussed herein. The negative impacts may cause a device to fail prior to meeting its service life. A service life may be a desired duration of operation of a component, device, or system.

To address the above and/or other potential issues, embodiments of the invention may provide methods, devices, and systems that mitigate corrosion. To mitigate corrosion, corrosion management components may be utilized. A corrosion management component may be a component that modifies an environment proximate to a component to manage the corrosion risk of the component.

To provide corrosion management services, the corrosion management components may modify the amount of humidity in an atmosphere that interacts with the components. For example, the corrosion management components may (i) remove humidity from an atmosphere when the conditions of the atmosphere are likely to place a component at risk of premature failure (e.g., prior to it meeting its service life) due to corrosion and (ii) add humidity to an atmosphere when the conditions of the atmosphere are unlikely to place a component at risk of premature failure due to corrosion.

For additional details regarding corrosion management components, refer to FIGS. 1.4-1.8.

In addition to managing corrosion using corrosion management components, a system in accordance with embodiments of the invention may actively manage whether corrosion management components are absorbing or expelling humidity. For example, a system may monitor the environmental conditions and/or rates of corrosion that are occurring to determine if a risk of corrosion for any number of components exists. If the risk of corrosion is low, the system may direct heat from components to the corrosion management components to cause the corrosion management components to expel humidity. If the risk of corrosion is high, the system may direct heat away from the corrosion management components to cause the corrosion management components to absorb humidity. By doing so, the system may manage the level of humidity within a chassis and/or at component levels to manage the risk of corrosion within the chassis.

To facilitate management of gases into and out of the chassis (100A, 100B, 100C), the frame (110) may include a door (112). The door may be used to limit access to the chassis through a front of the frame (110).

Additionally, the door (112) may include an air inlet (114). The air inlet (114) may enable gases to flow through the door (112) and into the air exchanges of the chassis. To facilitate management of components disposed within the chassis, the air inlet (114) may be formed from a corrosion management material. As will be discussed in greater detail below, the corrosion management material of the air inlet (114) may absorb humidity from the gases as they pass through the air inlet (114) to limit the relative humidity level of the gases when proximate to components disposed in the chassis. By doing so, the air inlet (114) may reduce the rate of corrosion of components disposed in the chassis. The air inlet (114) may be similar to a filter of a chassis (e.g., 196.2, FIG. 1.8), discussed in greater detail with respect to FIG. 1.8, and may provide humidity management services at a multi-chassis level.

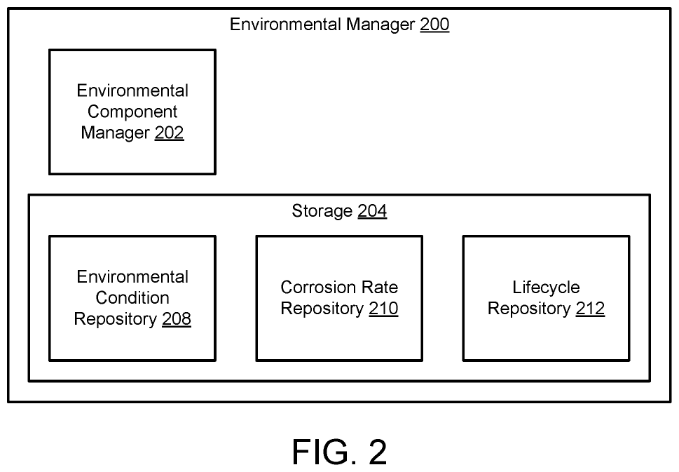

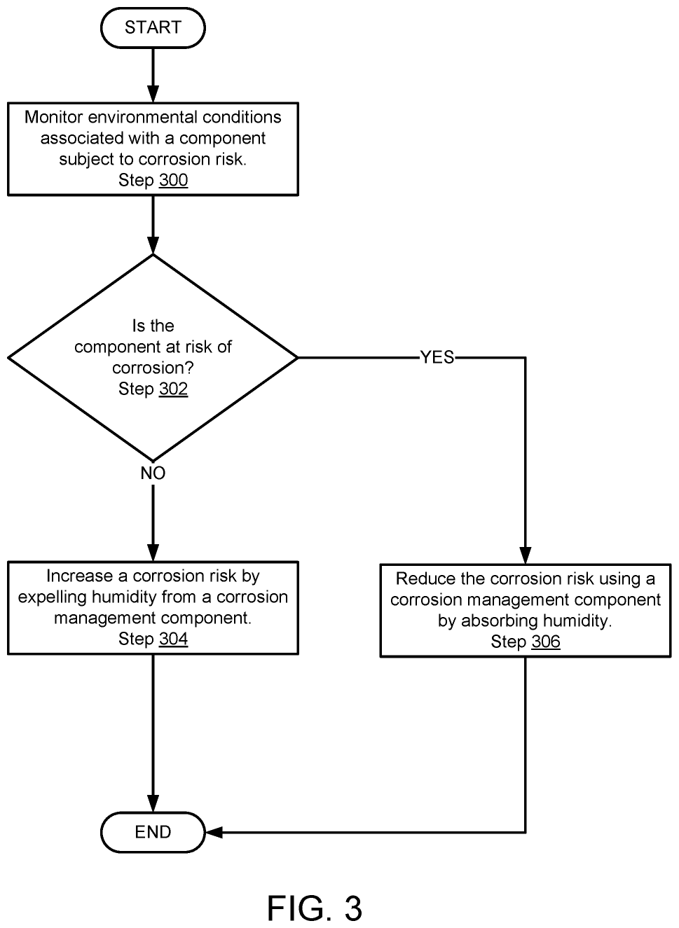

For additional details regarding environment management, refer to FIGS. 2-3.

To further clarify the environments in which corrosion may arise, a diagram of an environment in which a chassis may reside is illustrated in FIG. 1.2 and a diagram of a chassis is provided in FIG. 1.3.

Turning to FIG. 1.2, FIG. 1.2 shows a top view diagram of a building (115) in which chassis may reside in accordance with one or more embodiments of the invention. The building (115) may house a data center (e.g., an aggregation of information handling systems) that includes any number of information handling systems (e.g., 10A, 10B). The information handling systems may include chassis which may need to intake and exhaust gases for temperature regulation purposes.

To facilitate gas management within the building (115), the information handling systems may be organized into rows (or other groupings of information handling systems). In FIG. 1.2, the rows of information handling system extend from top to bottom along the page. To enable gases to be provided to the information handling systems (e.g., for temperature regulation purposes), an airflow conditioner (120) may be disposed within the building. The airflow conditioner (120) may provide supply airflow (122) and take in a return airflow (124). These airflows are illustrated as arrows having dashed tails.

The supply airflow (122) may be at lower temperature than the return airflow (124).

Consequently, when information handling systems obtain portions of the supply airflow (122), the information handling systems may be able to utilize the supply airflow (122) to cool components disposed within the chassis of the information handling systems. For example, gases from the supply airflow (122) may be passed by components disposed within chassis of information handling systems that are at elevated temperatures. The gases may be at a lower temperature than the components. Consequently, thermal exchange between the gases and the components may decrease the temperature of the components.

After utilizing the gases from the supply airflow (122), the information handling systems may exhaust the gases as the return airflow (124). After being exhausted from the information handling systems, the return airflow (124) may be obtained by the airflow conditioner (120), cooled, and recirculated as the supply airflow (122).

In addition to cooling the return airflow (124), the airflow conditioner (120) may be capable of obtaining gases from other areas (e.g., outside of the building), reducing the humidity level of an airflow, and/or otherwise conditioning gases for use by information handling systems and/or other devices. The gases from other areas may include significant amounts of humidity which may cause corrosion. However, these gases may be at lower temperatures than those in the return airflow (124). Consequently, use of other gases may enable less energy to be used to cool gases prior to being provided to the IHSs via the supply airflow (122) at the cost of risk of increased corrosion due to humidity.

To manage the aforementioned process of providing gases to the IHSs, a system environmental manager (130) may be disposed within the building (115) or at other locations. The system environmental manager (130) may be a computing device programmed to (i) obtain information regarding the operation of the information handling systems and (ii) set the operating points of the airflow conditioner (120). By doing so, the system environmental manager (130) may cause the airflow conditioner (120) to provide gases to the information handling systems having a temperature and/or humidity level that may better enable the information handling systems to regulate their respective environmental conditions within the chassis of the respective information handling systems. However, conditioning the supply airflow (122) may utilize large amounts of energy.

The airflow conditioner (120) may include functionality to granularly, or at a macro level, modify the temperature and/or humidity level of the supply airflow (122). Consequently, different information handling systems (or groups thereof) may receive different supply airflows (e.g., 122) having different characteristics (e.g., different temperatures and/or humidity levels, different sources, etc.).

Conditioning the return airflow (124) or gases obtained from outside of the building (115) may be costly, consume large amounts of electricity, or may otherwise be undesirable. To reduce these costs, the system environmental manager (130) may set the operating point (e.g., desired temperature/humidity levels of different portions of the supply airflow (122)) of the airflow conditioner (120) to only provide the minimum necessary characteristics required by each of the IHSs so that it meets is service life goals. By doing so, the cost of providing the supply airflow (122) having characteristics required to meet the environmental requirements of the chassis of the information handling systems may be reduced.

To decide how to set the operating points of the airflow conditioner (120), the system environmental manager (130) may obtain and/or be provided information regarding the environmental conditions within each of the chassis. For example, the system environmental manager (130) may be operably connected to environmental managers of each of the chassis and/or the airflow conditioner (120) via any combination of wired and/or wireless networks. The respective environmental managers of the chassis may provide such information to the system environmental manager (130) and/or service requests regarding the operating points of the airflow conditioner (120) via the operable connections. These decisions may be made, in part, based on the presence of corrosion management components that may enable the IHSs to receive gases having higher levels of humidity without causing premature failures of these IHSs.

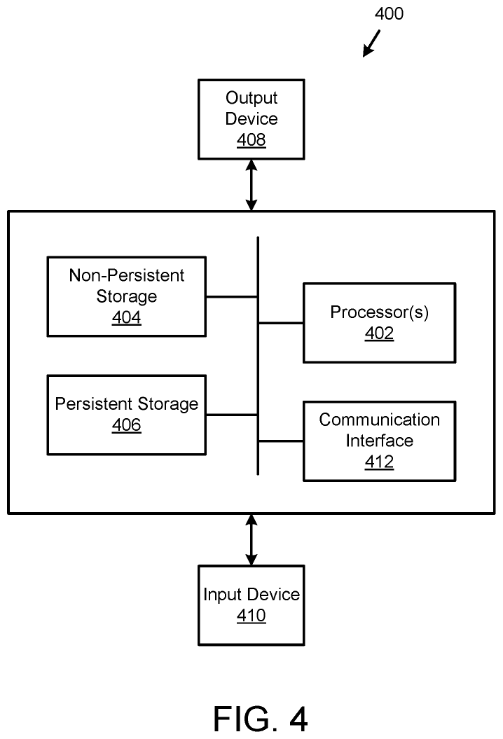

The system environmental manager (130) may be implemented using a computing device. For additional details regarding computing devices, refer to FIG. 4. The system environmental manager (130) may perform all, or a portion, of the method illustrated in FIG. 3 while providing its functionality.

Turning to FIG. 1.3, FIG. 1.3 shows a diagram of a chassis (100A) in accordance with one or more embodiments of the invention. A chassis may be a portion of an IHS and/or house all, or a portion, of an IHS. An information handling system may include a computing device that provides any number of services (e.g., computing implemented services). To provide services, the computing device may utilize computing resources provided by computing components (140). The computing components (140) may include, for example, processors, memory modules, storage devices, special purpose hardware, and/or other types of physical components that contribute to the operation of the computing device. For additional details regarding computing devices, refer to FIG. 4.

Because the computing device uses computing components (140) to provide services, the ability of the computing device to provide services is limited based on the number and/or quantity of computing devices that may be disposed within the chassis. For example, by adding additional processors, memory modules, and/or special purpose hardware devices, the computing device may be provided with additional computing resources which it may be used to provide services. Consequently, large number of computing components that each, respectively, generate heat may be disposed within the chassis.

To maintain the temperatures of the computing components (140) (and/or other types of components) within a nominal range, gases may be taken in through an air receiving exchange (102.2). The gases may be passed by the computing components (140) to exchange heat with them. The heated gases may then be expelled out of an air expelling exchange (102.4).

However, by taking in and expelling gases used for cooling purposes, the air receiving exchange (102.2), other portions of the chassis (100A) and/or components disposed within the chassis (100A) may be subject to degradation due to corrosion. For example, as discussed above, the gases may include components such as humidity or chemical species that may chemically react forming corrosion. The chemical reaction products (e.g., corrosion) may form corrosion, cause corrosion products to circulate in the chassis (and/or outside of the chassis by being expelled as part of heated gases), and/or damage the structure and/or change the electrical properties of the computing components (140). These changes may negatively impact the ability of the computing device to provide its functionality (e.g., cause total, or partial, premature failures).

For example, the computing device may have a service life during which it is expected that the computing device will be likely to provide its functionality. However, changes in the structure and/or electrical properties of these components due to exposure to humidity or other components of the gases used for temperature regulation purposes may cause the components to prematurely fail ahead of the service life of the computing device due to corrosion formation.

In general, embodiments of the invention provide methods, devices, and systems for managing corrosion within chassis. To manage corrosion, a system in accordance with embodiments of the invention may selectively remove and add humidity to the internal environment (104) of the chassis at different points in time. These points in time may coincide with when the various risks of corrosion of the computing components (140) are, in aggregate or individually, low or not low (e.g., elevated).

For example, the risk of corrosion of the computing components may increase as the level of relative humidity increases. Consequently, for constant levels of water vapor in the atmosphere, the relative humidity level may decrease as temperature level increases.

Due to changes in workloads of the computing components (140), the temperatures of the computing components may change over time. Accordingly, the risk of corrosion of the computing components may similarly change.

To address the changing risk of corrosion, corrosion management components (not shown) may be integrated into the chassis (100A) of FIG. 1.3. These corrosion management components may be used to selectively add and remove humidity from the internal environment (104) (generally or with respect to specific components) to address the changing risk of corrosion due to changes in temperatures of the computing components (140). Specifically, the corrosion management components may be used to remove humidity from the atmosphere when the temperatures of the computing components are at lower levels thereby reducing the likelihood of corrosion occurring. When the temperatures of the computing components are at elevated levels, the corrosion management components may expel humidity to improve their ability to remove humidity from the internal environment (104) in the future. As will be discussed with respect to FIGS. 1.6-1.7, corrosion management components may have finite limit on the amount of humidity they may absorb. Consequently, it may be necessary to replenish this capacity for future use at times when capacity replenishment is unlikely to negatively impact the computing components (140).

By doing so, embodiments of the invention may reduce the corrosion and/or components while reducing power consumption for conditioning of gases used for thermal regulation purposes. By doing so, the computing devices disposed within the chassis (100A) may be more likely to meet their respective service life goals, have lower operation costs, and/or require fewer repairs during their respective service life.

To manage the internal environment (104) of the chassis, the chassis (100A) may include a chassis environmental manager (150). The chassis environmental manager (150) may provide environmental management services. Environmental management services may include (i) monitoring the environmental conditions of the internal environment (104), (ii) when the environmental conditions indicate that corrosion is likely to occur (or occur at high rates), remove humidity from the internal environment (104), and (iii) when the environmental conditions indicate that corrosion is unlikely to occur (or occur at low rates), replenish the capacity of corrosion management components by expelling humidity from them. For additional details regarding the chassis environmental manager (150), refer to FIG. 2.

While illustrated in FIG. 1.3 as a physical structure, as will be discussed with respect to FIG. 2, the chassis environmental manager (150) may be implemented as a logical entity (e.g., a program executing using the computing components (140)). For example, a computing device disposed in the chassis may host a program that provides the functionality of the chassis environmental manager (150).

To enable the chassis environmental manager (150) to provide its functionality, the chassis (100A) may include one or more detectors (e.g., 154, 156). These detectors may enable the rates of corrosion (e.g., corrosion risk) of various components (e.g., computing components, etc.) to be determined and/or environmental conditions within and/or proximate to the computing components (140) to be determined. These detectors may be implemented as sensors or other types of physical devices that are operably connected to the chassis environmental manager (150). Any number of corrosion detectors (e.g., 154), temperature detectors (e.g., 156), humidity detectors (e.g., 156), and/or other types of detectors may be disposed at any number of locations throughout the chassis (100A).

In some embodiments of the invention, the functionality of a temperature detector may be provided by, in all or in part, the computing components (140). For example, the computing components (140) may include functionality to report their respective temperatures and/or temperatures of the internal environment (104) of the chassis (100A).

The chassis (100A) may also include environmental control components (152).

The environmental control components (152) may include physical devices that include functionality to (i) modify characteristics (e.g., temperature, humidity level, airflow rates/directions) of the internal environment (104) of the chassis (100A), (ii) transfer heat generated by one or more computing components to one or more corrosion management components, and/or (iii) supply heat to corrosion management components. The chassis (100A) may include any number of environmental control components disposed at any number of locations within the chassis.

For example, the environmental control components (152) may include gas movers such as fans. The fans may be able to modify the rate of gases being taken into and expelled from the chassis (100A) through the air exchangers (e.g., 102.2, 102.4). The rate of intake and exhaust of gases may cause an airflow to be generated within the internal environment (104). The airflow may be used to modify the rate of thermal exchange between the computing components (140) and the internal environment (104) (e.g., an environment proximate to the computing components (140)).

In another example, the environmental control components (152) may include heaters. The heaters may be able to modify the temperature of the internal environment (104) and/or corrosion management components. For example, heaters may be disposed on a corrosion management component disposed at an air receiving exchange (102.2). The heater may be used to control whether the corrosion management component is absorbing or expelling humidity. Consequently, the humidity level of computing components downstream from the corrosion management component may be modified by the corrosion management component.

In a still further example, the environmental control components (152) may include components that are not disposed in the chassis (not shown). For example, the environmental control components may include an airflow conditioner discussed with respect to FIG. 1.2. These external components may be used in conjunction with the environment control components disposed within the chassis to manage the temperature and/or relative humidity levels of gases provided to the chassis (100A) for thermal management purposes.

The chassis (100A) may include any number and type of environmental control components without departing from the invention. Any of the environmental control components may be implemented using physical devices operably connected to and/or controllable by the chassis environmental manager (150) and/or a system environmental manager (e.g., 130, FIG. 1.2) (alone or in combination). Any number of chassis environmental managers and system environmental managers may cooperatively operate to control the temperature and/or relative humidity levels to control the rate of corrosion occurring within the chassis and/or manage the thermal load generated by the computing components (140) and/or other components.

To cooperatively operate, the chassis environmental managers and system environmental managers may be operably connected to each another (e.g., via wired and/or wireless networks). The aforementioned components may share information with one another (e.g., detector data, operating set points of different environmental control components, etc.). These components may implement any type of model for controlling and/or delegating control of the system for temperature, relative humidity level, and/or corrosion rate management purposes. When providing their respective functionalities, these components may perform all, or a portion, of the method illustrated in FIG. 3. Any of these components may be implemented using a computing device. For additional details regarding computing devices, refer to FIG. 4.

While the chassis (100A) of FIG. 1.3 has been illustrated as including a limited number of specific components, a chassis in accordance with one or more embodiments of the invention may include additional, fewer, and/or different components without departing from the invention. Additionally, while the chassis (100A) is illustrated as having a specific form factor (e.g., rack mount), a chassis in accordance with embodiments of the invention may have different form factors without departing from the invention.

As discussed above, the chassis (100A) may include corrosion management components. The corrosion management components may be used to control corrosion of the air receiving exchange (102.2) and/or other portions of the chassis. To further clarify corrosion management components, FIGS. 1.4-1.8 show diagrams of corrosion management components and/or integrations of corrosion management components in accordance with one or more embodiments of the invention.

Turning to FIG. 1.4, FIG. 1.4 shows a diagram of computing components (140) in accordance with one or more embodiments of the invention. The computing components (140) may enable computing devices to provide services, as discussed above.

The computing components (140) may include any number of discrete hardware devices (160). The discrete hardware devices (160) may include, for example, packaged integrated circuits (e.g., chips), modules (e.g., random access memory modules) including circuit cards operably connected to other hardware devices through connectors (e.g., 164.8) to other circuit cards, and/or other types of hardware components. The discrete hardware devices (160) may enable any number and type of functionalities to be performed by a computing device.

The computing components (140) may also include a circuit card (e.g., 164.6). The circuit card may enable any of the discrete hardware devices (160) to be operably connected to one another and/or other components not illustrated in FIG. 1.4. For example, the circuit card may include a multiplayer printed circuit board that includes circuitry.

The circuitry of the circuit may include traces (162) (e.g., metal wires formed from sheets of metal disposed on dielectric layers of the circuit card) that electrically interconnect various discrete hardware devices (160) to one another and/or other components not illustrated in FIG. 1.4. The traces (162) may be formed out of conductive materials such as copper thereby enabling electrical power to be provided to the discrete hardware devices (160), electrical signals to be distributed among the discrete hardware devices (160), etc.

Returning to the discrete hardware devices (160), these devices may consume electrical power and generate heat as a byproduct of performing their functionality. Further, the discrete hardware devices (160) may have some sensitivity to temperature. For example, the discrete hardware devices (160) may only operate nominally (e.g., as designed) when the temperatures of the respective discrete hardware devices (160) are maintained within a preferred temperature range. Consequently, all, or a portion, of the discrete hardware devices (160) may require some level of cooling to continue to operate nominally.

As discussed above, to facilitate cooling of the discrete hardware devices (160), airflows within the chassis may be generated by environmental control components such as fans, etc. The airflows may cause gases that are at different temperatures and/or relative humidity levels to be taken into the chassis, used for cooling purposes, and then expelled from the chassis. Consequently, if the temperatures of the discrete hardware devices (160), traces (162), and/or other components are at sufficiently low levels, the corrosion rates of these components may increase thereby causing significant corrosion risk.

To mitigate the corrosion risk, corrosion management components may be integrated with these components. The corrosion management components, as discussed above, may absorb and release humidity to mitigate the risk of corrosion by modifying the atmospheric conditions proximate to the at risk components. These components are highlighted in FIG. 1.4 using dotted infill.

In one or more embodiments of the invention, the corrosion management components include discrete corrosion management components (e.g., 164.2). A discrete corrosion management component (164.2) may be a physical structure disposed at a location proximate to a component for which it is to provide corrosion management services. A discrete corrosion management component (164.2) may be disposed upstream to the component which it is to manage.

For example, consider a scenario where a discrete corrosion management component (164.2) is disposed upstream of traces (162). When gases with humidity pass by the discrete corrosion management component (164.2), the discrete corrosion management component (164.2) may absorb part of the humidity in the gases thereby decreasing the relative humidity level of the gases. Consequently, when the gases flow downstream proximate to the traces (162), the humidity level of the gases may be such that the traces (162) are not placed at risk of corrosion related premature failure.

In one or more embodiments of the invention, the corrosion management components include inter-device connector integrated corrosion management components (e.g., 164.4). An inter-device connector integrated corrosion management component (164.4) may be a physical structure that enables the discrete hardware devices (160) to be operably connected to other devices (e.g., storage such as disk drives, other computing devices, etc.). To do so, the inter-device connector integrated corrosion management components (164.4) may include a connector. The connector may receive cabling or other structures that enable signals to be carried between the discrete hardware devices (160) and other devices (not shown).

The connector may be formed, in part, from material that performs the functionality of a corrosion management component. For example, if a connector includes a plastic housing and metal pins, the plastic housing may be formed from a material that performs the functionality of the corrosion management component. Consequently, electrical connections between the pins and corresponding structures on cabling may have their corrosion risk managed by the inter-device connector integrated corrosion management components (164.4). For additional details regarding a material that performs the functionality of the corrosion management component, refer to FIGS. 1.6-1.7.

In one or more embodiments of the invention, the corrosion management components include a circuit card integrated corrosion management component (164.6). A circuit card integrated corrosion management component (164.6) may be a physical structure that enables the discrete hardware devices (160) to be operably connected to each other. To do so, the circuit card integrated corrosion management component (164.6) may include a circuit card that includes the traces (162).

The circuit card integrated corrosion management component (164.6) may also include a layer that performs the functionality of a corrosion management component. For example, the circuit card integrated corrosion management component (164.6) may include a layer of material, disposed on the circuit card, that absorbs and releases humidity, as noted above. Consequently, the circuit card integrated corrosion management component (164.6) may enable the discrete hardware devices (160) to communicate with each other while managing the corrosion risk of the circuit card that enables these devices to communicate.

In one or more embodiments of the invention, the corrosion management components include a discrete hardware connector integrated corrosion management component (164.8). The discrete hardware connector integrated corrosion management component (164.8) may be a physical structure that enables discrete hardware devices (e.g., 160) to be operably connected to the traces (162) of the circuit card integrated corrosion management component (164.6). To do so, the discrete hardware connector integrated corrosion management component (164.8) may include a connector (e.g., a card/module slot). The connector may receive a corresponding connector of a discrete hardware device.

The connector may be formed, in part, from material that performs the functionality of a corrosion management component. For example, if a connector includes a plastic housing and metal pins, the plastic housing may be formed from a material that performs the functionality of the corrosion management component. Consequently, electrical connections between the pins and corresponding structures on cabling may have their corrosion risk managed by the inter-device connector integrated corrosion management components (164.4). For additional details regarding a material that performs the functionality of the corrosion management component, refer to FIGS. 1.6-1.7.

While the computing components (140) are illustrated in FIG. 1.4 as including a number of corrosion management components, computing components in accordance with one or more embodiments of the invention may only include a subset of these corrosion management components and/or may include additional and/or different corrosion management components.

Additionally, while not illustrated in FIG. 1.4, any of the corrosion management components may be integrated with an environmental management component. The environmental management component may be utilized to control when the corrosion management component is absorbing or expelling humidity. For example, a thermal management component (142) such as a heat sink may be utilized to extract heat from discrete hardware devices. The extracted heat may be utilized to heat corrosion management components to cause them to expel humidity. Consequently, the humidity absorption capacity of the corrosion management components may be renewed.

In another example, heaters (not shown) may be integrated with corrosion management components. The heaters may be controlled by an environmental controller thereby enabling the environmental manager to selectively expel humidity from the corrosion management components by selectively heating the corrosion management components.

For additional details regarding integration of environmental management components with corrosion management component, refer to FIG. 1.8.

As discussed above, a circuit card integrated corrosion management component may be utilized to manage corrosion within a chassis. FIG. 1.5 shows a side view diagram of the circuit card integrated corrosion management component (164.6) in accordance with one or more embodiments of the invention.

To operably connect discrete hardware components and/or other devices to one another, the circuit card integrated corrosion management component (164.6) may include any number of metal/dielectric layers (170). The circuit card integrated corrosion management component (164.6) may include any number of such layers. The metal layers may be structured into circuitry including, for example, traces. The metal layers may be used to electrically connect different components to one another.

The dielectric layers may electrically isolate portions of the metal layers from one another. For example, the metal/dielectric layers (170) may form a circuit card having different layers of metallization structured to electrically interconnect any number of components.

The circuit card integrated corrosion management component (164.6) may also include a corrosion management layer (172). The corrosion management layer (172) may be, for example, a layer adhered to the backplane of a circuit card.

The corrosion management layer (172) may perform the function of a corrosion management component, discussed above. For example, the corrosion management layer (172) may absorb and expel humidity depending on the environmental conditions and/or temperature of various portions of the metal/dielectric layers (170). The corrosion management layer (172) may include corrosion management material as further discussion with respect to FIGS. 1.6-1.7.

While the corrosion management layer (172) is illustrated in FIG. 1.5 as covering an entire size of the metal/dielectric layers (170), the corrosion management layer (172) may be of different size than the metal/dielectric layers (170). Consequently, the corrosion management layer (172) may only cover a portion of the metal/dielectric layers (170).

Additionally, while illustrated in FIG. 1.5 as being one continuous structure, the corrosion management layer (172) may include physically distinct portions, each of the portions may have similar or different humidity absorption capacities (e.g., may be thicker/thinner).

As noted above, corrosion management components may include corrosion management materials. FIG. 1.6 shows a side view diagram of a chunk of corrosion management material (180) in accordance with one or more embodiments of the invention. In FIG. 1.6, the dashed lines indicate that the chunk of corrosion management material (180) may continue to the left and/or right of the page.

The corrosion management material (180) may be utilized to manage corrosion within and/or of a chassis. To do so, the corrosion management material (180) may absorb humidity from an ambient environment when the ambient environment creates an unacceptable risk of corrosion. In other words, when the relative humidity due to the amount of water vapor and temperature of the environment are likely to cause a component to corrode at a rate that is likely to lead to premature failure of the component.

To reversibly absorb humidity from the ambient environment, the corrosion management material (180) may include desiccant (182). The desiccant (182) may be a material that tends to absorb water until the relative humidity falls below a predetermined threshold. When the relative humidity falls below the predetermined threshold, the desiccant may expel humidity. Accordingly, the desiccant (182) may be used to absorb humidity to decrease the relative humidity level thereby reducing the rate of corrosion of a component when the environmental conditions would otherwise result in an unacceptable rate of corrosion.

The desiccant (182) may be implemented as a plurality of particles. The particles may be formed from a hygroscopic material. The hygroscopic material may include, for example, silica, activated charcoal, calcium sulfate, calcium chloride, zeolites, or other materials that may be utilized to reversibly absorb humidity from gases. The quantity of desiccant (182) may determine the quantity of humidity which the corrosion management component may be able to absorb.

In one or more embodiments of the invention, the desiccant (182) is embedded in a support material (184). The support material may enable a shape of the desiccant (182) to be maintained. If a corrosion management component is implemented as an integrated component, the support material (184) may be used to form a shape corresponding to a function for which the integrated component is to perform. For example, if the corrosion management component is also to form a connector (e.g., 164.4), the support material (184) may be formed into a shape corresponding to a form factor corresponding to the connector (e.g., corresponding to serial AT attachment connectors, parallel ATA connector form factors, etc.). Pins, wires, and/or other structures may be implemented with the support material to form a functional connector.

If implemented as a discrete corrosion management component, the support material (184) may enable the desiccant (182) to be formed into a shape that enables the resulting corrosion management component to be integrated with the component for which it provides corrosion management services. For example, the support material (184) may be formed into sheets, bars, etc.

To form the shapes of the support material, plastic injection molding, machining, or other shaping technologies may be utilized. For example, if injection molding is used, silica particles may first be disposed into a feedstock (e.g., a thermoplastic) to form silica loaded feedstock. The feedstock may then be heated and injected into a mold to shape the silica loaded feedstock into a predetermined shape. Consequently, any number of components may be formed using corrosion management materials to form corrosion management material integrated components. These resulting components may perform both their base function as well as provide corrosion management services.

While the corrosion management material (180) has been illustrated as having a specific form and including a specific number and type of components, a corrosion management material may have different forms and may include different, fewer, and/or additional components without departing from the invention.

For example, a corrosion management material may be formed as a filter material (e.g., screen) coated in desiccant. The filter may be formed from a metal form or other open cell type of material. The filter material may limit the size of particles that may pass through it. The filter material may be coated in a layer of desiccant using any process. The desiccant coated material may be formed into any desired shape.

To further clarify aspect of a corrosion management material that includes a desiccant layer, FIG. 1.7 shows a side view diagram of the corrosion management material (180) in accordance with one or more embodiments of the invention. As illustrated in FIG. 1.7, the desiccant (182) is disposed on surfaces of the support material (184). By doing so, the humidity absorbing desiccant (182) may be more easily able to absorb humidity by virtue of the larger contact area with the ambient environment.

To form the corrosion management material (180) as illustrated in FIG. 1.7, binder layers (183) (e.g., an adhesive material such as a glue) may be deposited on a support material (184) of any shape using any suitable process (e.g., spray coating). The desiccant (182) may then be deposited onto the binder layer (183) using any suitable process (e.g., dipping the binder covered support material into the desiccant, spraying desiccant onto the binder layer, etc.). The binder material may then be cured to form the binder layers (183). The binder layers (183) may fixedly attached the desiccant (182) to the support material (184).

While illustrated in FIG. 1.7 as covering all of the surfaces of the support material (184), the binder layers (183) and desiccant (182) may be selectively deposited on to the support material to provide some portions of the support material that are covered in the desiccant (182) while other portions are not covered.

In another example, the corrosion management material may be formed only from desiccant. The desiccant may be of any shape (e.g., a block of silica machined to a desired shape).

As discussed above, corrosion management components may be utilized to locally manage corrosion (e.g., on a per component level where a corrosion management component only provides corrosion management component for a corresponding component) or to manage corrosion on a multi-component level. FIG. 1.8 shows a top view diagram of a chassis (190) that manages corrosion on a multi-component level in accordance with embodiments of the invention.

The chassis (190) may house computing components including, for example, a processor (192.2), memory modules (192.4), and traces (192.6) that interconnect the processor and memory modules. Each of these computing components may be subject corrosion.

To perform their respective functionalities, each of these computing components may generate heat when providing their functionality. To manage the heat generated by these components, the chassis (190) may include fans (194.2). The fans (194.2) may generate an airflow (194.6) that extracts the heat generated by the computing components.

For example, the airflow (194.6) may draw in gases from an air source (194.4) into the chassis (190) through the air receiving exchange (102.2). The gases may be at a lower temperature than the processor, traces, and/or memory modules. The gases may pass proximate to the processor, memory modules, and traces to cause thermal exchange with the gases. After thermal exchange, the gases may be expelled out of an air exhausting exchange (102.4). By doing so, the interior of the chassis (190) may be cooled to maintain the temperature of the processor and memory modules within nominal ranges.

However, the airflow (194.6) may include humidity. Depending on the relative humidity level due to the humidity, the airflow (194.6) may cause the computing component to corrode at unacceptable rates (e.g., rates that are likely to lead to a premature failure of the computing components).

To manage this corrosion risk, the chassis (190) may include an air filter integrated corrosion management component (196.2) that provides corrosion management services to the computing components. To do so, the air filter integrated corrosion management component (196.2) may be a filter through which the airflow (194.6) is received at the air receiving exchange (102.2) of the chassis. The air filter integrated corrosion management component (196.2) may include a corrosion management material, as discussed with respect to FIG. 1.6, thereby causing it to absorb humidity from the airflow (194.6) when the airflow (194.6) would be likely to cause unacceptable levels of corrosion of the computing components.

To manage the humidity absorption capacity of the air filter integrated corrosion management component (196.2), the chassis (190) may include a heat exchanger/heater (196.4). The heat exchanger/heater (196.4) may be managed by an environmental manager to preferentially heat the air filter integrated corrosion management component (196.2) when the airflow (194.6) is unlikely to cause the computing components to corrode at unacceptable rates.

For example, the heat exchanger/heater (196.4) may be operated during periods of time where the computing components are performing heavy workloads thereby placing them at elevated temperature. When at elevated temperature, even large amounts of humidity entrained in the airflow (194.6) may not result in significant corrosion of the computing components. To determine when the computing components are at elevated temperatures, the chassis (190) may include one or more detectors (191) used to measure the temperature of these components.

If the heat exchanger/heater (196.4) is implemented as a heat exchanger, the heat exchanger may be thermally coupled to a thermal manager (192.8) disposed on the processor (192.2) using heat pipes (196.6). The thermal manager (192.8) may selectively extract heat generated by the processor (192.2) and transmit the extracted heat to the heat exchanger by way of the heat pipes. The amount of heat extracted may be controlled by the environmental manager thereby enabling the environmental manager to selectively heat the air filter integrated corrosion management component (196.2) using heat generated by the processor (192.2) and transferred into it via the heat exchanger.

However, the heating of the air filter integrated corrosion management component (196.2) may result in the airflow (194.6) being at elevated temperature while one or more of the components are also at elevated temperature. Consequently, the airflow (194.6) may be less able to cool components that are at elevated temperature while the capacity of the corrosion management components is recovered using the heat.

The thermal manager (192.8) may extract heat from other components without departing from the invention.

If the heat exchanger/heater (196.4) is implemented as a heater (e.g., a resistive heater), the heater may perform the same functionality as discussed above with respect to the heat exchanger. However, the heater may selectively generate heat as directed by an environmental manager rather than obtain the heat from other components.

While illustrated in FIG. 1.8 with respect to an air filter integrated corrosion management component (196.2), other types of corrosion management components may be integrated with environmental management components such as heat exchangers or heaters without departing from the invention.

While the chassis (190) of FIG. 1.8 has been illustrated as including a limited number of specific components, a chassis in accordance with one or more embodiments of the invention may include additional, different, and/or fewer components without departing from the invention. For example, the memory modules (192.4) may be disposed in connectors that include corrosion management materials. In another example, discrete corrosion management components may be disposed proximate to the traces (192.6). Thus, corrosion of any of the components of the chassis (190) may be managed at a macro level (e.g., using an air filter integrated corrosion management component (196.2) and a component level without departing from the invention.

Like the air filter integrated corrosion management component (196.2), an air inlet of a frame, as discussed with respect to FIG. 1.1, may provide similar functionality. However, rather than managing humidity for multiple components in a chassis like the air filter integrated corrosion management component (196.2), an air inlet may do so for multiple chassis and all of the corresponding components disposed therein.

To reduce the likelihood of premature failure of IHSs due to corrosion, an IHS in accordance with embodiments of the invention may include an environmental manager. Turning to FIG. 2, FIG. 2 shows a diagram of an environmental manager (200) in accordance with one or more embodiments of the invention. The system environmental manager (130) and/or chassis environmental manager (150) illustrated in FIGS. 1.2 and 1.3, respectively, may be similar to the environmental manager (200).

As discussed above, the environmental manager (200) may provide environmental management services. Environmental management services may reduce the likelihood that IHSs fail prematurely (e.g., prior to meeting service life goals) due to corrosion of computing components.

In one or more embodiments of the invention, the environmental manager (200) is implemented using computing devices. The computing devices may be, for example, mobile phones, tablet computers, laptop computers, desktop computers, servers, distributed computing systems, embedded computing devices, or a cloud resource. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to provide the functionality of the environmental manager (200) described through this application and all, or a portion, of the method illustrated in FIG. 3. The environmental manager (200) may be implemented using other types of computing devices without departing from the invention. For additional details regarding computing devices, refer to FIG. 4.

In one or more embodiments of the invention, the environmental manager (200) is implemented using distributed computing devices. As used herein, a distributed computing device refers to functionality provided by a logical device that utilizes the computing resources of one or more separate and/or distinct computing devices. For example, in one or more embodiments of the invention, the environmental manager (200) is implemented using distributed devices that include components distributed across any number of separate and/or distinct computing devices. In such a scenario, the functionality of the environmental manager (200) may be performed by multiple, different computing devices without departing from the invention.

To provide environmental management services, the environmental manager (200) may include an environmental component manager (202) and a storage (204). Each of these components is discussed below.

The environmental component manager (202) may manage environmental control components and/or corrosion management components that may be used to control the characteristics (e.g., temperature, humidity level, airflow rates, etc.) of the environment of the chassis. To manage them, the environmental component manager (202) may (i) obtain information regarding the environmental conditions including temperatures, humidity levels, airflow rates, humidity absorption capacities of corrosion management components, and/or corrosion rates, (ii) determine, using the environmental condition information, whether the IHS is likely to prematurely fail due to corrosion, and (iii) if the IHS is unlikely to meet its service life goals due to premature failure, modify the characteristics of the environment and/or of the chassis to improve the likelihood that the IHS will meet its service life goals.

To obtain information regarding the environmental conditions, the environmental component manager (202) may request such information from computing components (e.g., temperatures), detectors (e.g., corrosion, temperature, humidity, and/or other types of sensors), and/or other types of devices (e.g., components external to the chassis). In response, the aforementioned components may provide the requested information to the environmental component manager (202). The environmental component manager (202) may store the aforementioned information as part of an environmental condition repository (208).

To ascertain whether an IHS is likely to prematurely fail due to corrosion, the environmental component manager (202) may estimate a total amount of corrosion of different portions of a chassis that has likely occurred, estimate the rate that corrosion will occur in the future, and use the previous amount and current rate to determine to modify the environmental conditions within the chassis.

Utilizing these estimates, the environmental component manager (202) may determine whether the IHS is unlikely to meet its service life goal due to corrosion. To make this determination, the environmental component manager (202) may utilize a lifecycle repository (212). The lifecycle repository (212) may specify information that may be used to ascertain whether a premature failure will occur based on corrosion. For example, the lifecycle repository (212) may specify a total amount of corrosion that will cause various corrosion management components to no longer be able to provide corrosion management services. Based on this total amount and the corrosion rate associated with the corrosion management component, the environmental component manager (202) may ascertain whether the amount of corrosion specified by the lifecycle repository (212) will be exceeded prior to the occurrence of the service life of the IHS.

If it is determined that the IHS will prematurely fail due to corrosion, the environmental component manager (202) may modify the environment of the IHS. For example, the environmental component manager (202) may utilize a corrosion management component to absorb humidity from an environment near a component that is likely to cause an IHS due to corrosion of the component.

For example, the IHS may decrease the temperature of the corrosion management component to cause the corrosion management component to begin to absorb humidity from an ambient environment. Consequently, the relative humidity of the environment proximate to the component may be reduced. Accordingly, the rate of corrosion of the component may be reduced thereby mitigating the threat of failure of the component due to corrosion.

If it is determined that the IHS is unlikely to prematurely fail due to corrosion, the environmental component manager (202) may modify the environment of the IHS to replenish the humidity absorption capacity of one or more corrosion management components. For example, the environmental component manager (202) may generate or direct generated heat to the one or more corrosion management components. The heat may cause the corrosion management component to expel humidity thereby replenishing the humidity absorption capacity of the one or more corrosion management components.

When providing its functionality, the environmental component manager (202) may utilize the storage (204) by storing and using previously stored data structures.

To provide the above noted functionality of the environmental component manager (202), the environmental component manager (202) may perform all, or a portion, of the method illustrated in FIG. 3.

In one or more embodiments of the invention, the environmental component manager (202) is implemented using a hardware device including circuitry. The environmental component manager (202) may be implemented using, for example, a digital signal processor, a field programmable gate array, or an application specific integrated circuit. The environmental component manager (202) may be implemented using other types of hardware devices without departing from the invention.

In one or more embodiments of the invention, the environmental component manager (202) is implemented using computing code stored on a persistent storage that when executed by a processor performs all, or a portion, of the functionality of the environmental component manager (202). The processor may be a hardware processor including circuitry such as, for example, a central processing unit or a microcontroller. The processor may be other types of hardware devices for processing digital information without departing from the invention.

In one or more embodiments disclosed herein, the storage (204) is implemented using devices that provide data storage services (e.g., storing data and providing copies of previously stored data). The devices that provide data storage services may include hardware devices and/or logical devices. For example, storage (204) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (204) may include a memory device (e.g., a dual in line memory device) in which data is stored and from which copies of previously stored data are provided. In another example, storage (204) may include a persistent storage device (e.g., a solid state disk drive) in which data is stored and from which copies of previously stored data are provided. In a still further example, storage (204) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (204) may store data structures including an environmental condition repository (208), a corrosion rate repository (210), and a lifecycle repository (212). Each of these data structures is discussed below.

The environmental condition repository (208) may include one or more data structures that include information regarding the environmental conditions associated with a chassis. For example, when temperature, humidity, airflow rate, and/or corrosion data is read from a detector, the read information may be stored in the environmental condition repository (208). Consequently, a historical record of the environmental conditions in the repository may be maintained.

Similarly, when a corrosion management component is used to absorb humidity, the quantity absorbed may be estimated. By doing so, the remaining humidity absorption capacity of the corrosion management component may be monitored.

The environmental condition repository (208) may include any type and quantity of information regarding the environmental conditions within the repository. For example, the environmental condition repository (208) may include temperature sensor data from discrete temperature sensors and/or temperature sensors integrated into computing components (and/or other types of devices). In another example, the environmental condition repository (208) may include corrosion rates from discrete or integrated corrosion sensors (e.g., on board a circuit card). In a still further example, the environmental condition repository (208) may include airflow rate data regarding the flow of gases within a chassis.

In addition to the sensor data, the environmental condition repository (208) may include spatial data regarding the relative locations of portions of a chassis. For example, some portions of a chassis may be disposed away from the detectors. Consequently, it may not be possible to directly measure the temperature, relative humidity level, humidity absorption rates, humidity expulsion rates, airflow rates, and/or corrosion levels of components. The spatial data may be used to estimate, using measured temperatures, humidity levels, and/or corrosion, the likely corresponding environmental conditions proximate to other components. For example, the environmental condition repository (208) may include correction factors used to translate detector measurements to estimates of local environmental conditions proximate to components disposed away from the detectors.

Additionally, the environmental condition repository (208) may include information regarding whether components disposed in a chassis are associated with corrosion management components that provide corrosion management services to these components. For example, if a component is exposed to a temperature of 70° Fahrenheit and 70% relative humidity, the environmental condition repository (208) may specify that the component has a high rate of corrosion. However, if the component is associated with a corrosion management component, the environmental condition repository (208) may specify a reduction factor that may be applied to the corrosion rate to obtain an estimate of the corrosion rate of the component that takes into account the presence of the corrosion management component.

The corrosion rate repository (210) may include one or more data structures that include information regarding the rates at which components have corroded. For example, the corrosion rate repository (210) may include tables associated with different components. Each of these tables may include the measured and/or estimated corrosion of these components.

The tables may also include the time at which the corrosion was measured. Consequently, the rates of corrosion of the components may be ascertained using the information included in the tables (e.g., corrosion at time T1−corrosion at time T2/the different between T1 and T2).

The lifecycle repository (212) may include one or more data structures that include information regarding the desired life of an information handling system. For example, the lifecycle repository (212) may specify how much corrosion may occur with respect to different components (e.g., computing components) before the respective components are likely to fail and/or the IHS is likely to fail due to failures of the components. The aforementioned information may be used in conjunction with determined corrosion rates and quantities of corrosion included in the corrosion rate repository (210) to determine whether it is likely that a component, computing device, and/or IHS is likely to fail prior to its desired service life.

While the data structures stored in storage (204) have been described as including a limited amount of specific information, any of the data structures stored in storage (204) may include additional, less, and/or different information without departing from the embodiments disclosed herein. Further, the aforementioned data structures may be combined, subdivided into any number of data structures, may be stored in other locations (e.g., in a storage hosted by another device), and/or spanned across any number of devices without departing from the embodiments disclosed herein. Any of these data structures may be implemented using, for example, lists, table, linked lists, databases, or any other type of data structures usable for storage of the aforementioned information.

While the environmental manager (200) of FIG. 2 has been described and illustrated as including a limited number of specific components for the sake of brevity, an environmental manager in accordance with embodiments of the invention may include additional, fewer, and/or different components than those illustrated in FIG. 2 without departing from the invention.

Further, any of the components may be implemented as a service spanning multiple devices. For example, multiple computing devices housed in multiple chassis may each run respective instances of the environmental component manager (202). Each of these instances may communicate and cooperate to provide the functionality of the environmental component manager (202).

As discussed above with respect to FIG. 2, the environmental manager (200) may provide corrosion management services. FIG. 3 illustrates a method that may be performed by the environmental manager (200) of FIG. 2 when providing corrosion management services.

FIG. 3 shows a flowchart of a method in accordance with one or more embodiments of the invention. The method depicted in FIG. 3 may be used to manage corrosion of computing components disposed in a chassis in accordance with one or more embodiments of the invention. The method shown in FIG. 3 may be performed by, for example, an environmental manager (e.g., 200, FIG. 2). Other components of the system illustrated in FIGS. 1.1-2 may perform all, or a portion, of the method of FIG. 3 without departing from the invention.

While FIG. 3 is illustrated as a series of steps, any of the steps may be omitted, performed in a different order, additional steps may be included, and/or any or all of the steps may be performed in a parallel and/or partially overlapping manner without departing from the invention.

In step 300, environmental conditions associated with a component subject to corrosion risk is monitored. The component may be a computing component disposed in a chassis.

The environmental conditions may be monitored using detector measurements of the environment in which the component resides. For example, the temperature, relative humidity level, and/or other conditions that may impact corrosion of the component and associated corrosion management component may be monitored using detectors. These measurements may be used as the environmental conditions.

In step 302, it is determined whether the component is at risk of corrosion. As noted above, a component may be at risk of corrosion when the corrosion may cause the component to fail prior to it meeting its service life and/or the service of a computing device of which the component is a member.

The determination may be made based on information included in an environmental condition repository (208, FIG. 2). For example, the information may be used to determine a rate of corrosion of the component. If the rate of corrosion indicates that the component will prematurely fail before meeting its service life, the component may be determined as being at risk of corrosion.

If it is determined that the component is at risk of corrosion, the method may proceed to step 306. If it is determined that the component is not as risk of corrosion, the method may proceed to step 304.

In step 304, the corrosion risk is increased by expelling humidity from a corrosion management component that provides corrosion management services to the component. For example, the environmental manager may apply heat to the corrosion management component to cause it to expel the humidity. The heat may be applied using a heater or may be extracted from the component (e.g., processor, graphics processing unit, etc.) and deposited into the corrosion management component. For example, the component may be caused to perform a dummy workload (i.e., one performed simply to cause heat generation rather than performing useful computations) or otherwise generate heat.

Causing the corrosion management component to expel humidity may also heat an airflow upstream of the component. The component may be at elevated temperature when the humidity is expelled. Consequently, the rate of corrosion of the component may be negligibly impacted due to the humidity added to the airflow.

Expelling the humidity from the corrosion management component may renew the humidity absorption capacity of the corrosion management component.

The method may end following step 304.

Returning to step 302, the method may proceed to step 306 if it is determined that the component is at risk of corrosion.

In step 306, the corrosion risk is reduced by absorbing humidity using a corrosion management component. The humidity absorbed by the corrosion management component may reduce the relative humidity level proximate to the component. Consequently, the rate of corrosion and corresponding corrosion risk of the component may be reduced.

The humidity may be reduced by reducing a temperature of the corrosion management component to cause it to absorb humidity (e.g., by increasing the relative humidity level proximate to the corrosion management component by a cooling it). The temperature reduction may be performed actively by utilizing an environmental control component such as a fan or passively by not actively heating or directing heat towards the corrosion management component). By doing so, the environmental conditions proximate to the corrosion management component may be conductive to the absorption of humidity by the corrosion management component.

In some cases, the corrosion risk may only be able to be partially reduced by the corrosion management components. For example, the corrosion management components may not be able to absorb a sufficient quantity of humidity to reduce the corrosion risk to a desired level due to the limited water absorption capacity of the corrosion management components (e.g., could have previously absorbed water and has limited ability to absorb additional water). In such a scenario, other methods of reducing humidity may be employed. For example, environmental management components such as heaters, gas movers, or other types of components may be activated to further reduce the corrosion risk (e.g., modifying the ambient temperature and/or relative humidity level) until it reaches a desirable level. However, activation of these components may be avoided unless needed due to the corresponding energy expenditures associated with activating these components.

The method may end following step 306.

Using the method illustrated in FIG. 3, embodiments of the invention may provide a system that manages corrosion of components of an IHS to meet service life goals.

Any of the components of FIG. 2 may be implemented as distributed computing devices. As used herein, a distributed computing device refers to functionality provided by a logical device that utilizes the computing resources of one or more separate and/or distinct computing devices.

Additionally, as discussed above, embodiments of the invention may be implemented using a computing device. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Embodiments of the invention may provide an improved method for managing components of an information handling system. Specifically, embodiments of the invention may provide a method and device for managing corrosion of computing components of an IHS using corrosion management components. To do so, the corrosion management components may be used to selectively absorb humidity while the risk of corrosion is high and expel humidity while the risk of corrosion is low. By doing so, the relative humidity proximate to the computing component may be maintained within a range that results in low levels of corrosion of the computing components. Consequently, a risk of corrosion related failure of the IHS may be reduced.

Thus, embodiments of the invention may address the problem of environments that may cause undesired corrosion. Specifically, embodiments of the invention may provide a method of managing corrosion that enables corrosion sensitive components to be utilized in corrosive environments while mitigating the risks of the corrosion.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A computing device of an information handling system, comprising:
a computing component associated with a risk of corrosion; and
a corrosion management component adapted to:
release humidity into an environment associated with the computing component while the risk of corrosion due to the environment is a low risk of corrosion, and
absorb humidity from the environment associated with the computing component while the risk of corrosion due to the environment is a high risk of corrosion.

2. The computing device of claim 1, wherein the high risk of corrosion indicates that the computing device is unlikely to meet its service life goal due to an impact of corrosion on the computing device.

3. The computing device of claim 2, wherein the low risk of corrosion indicates that the computing device is likely to meet its service life goal regardless of the impact of corrosion on the computing device.

4. The computing device of claim 1, wherein the corrosion management component comprises a corrosion management material comprising:
a desiccant adapted to:
absorb the humidity, and
release the humidity; and
a support material.

5. The computing device of claim 4, wherein the desiccant comprises a plurality of particles embedded in the support material.

6. The computing device of claim 1, wherein the corrosion management component is a discrete management component disposed at a location upstream of an airflow associated with the computing component.

7. The computing device of claim 1, wherein the corrosion management component is an inter-device connector integrated corrosion management component adapted to enable the computing device to operably connect with another device.

8. The computing device of claim 1,
wherein the corrosion management component is a discrete hardware device connector integrated corrosion management component adapted to enable the computing component to operably connect to a second computing component,
wherein the computing component is disposed on a circuit card separate from a second computing card on which the second computing component is disposed.

9. The computing device of claim 1, wherein the corrosion management component is a circuit card integrated corrosion management component adapted to operably connect the computing component with a second computing component.

10. The computing device of claim 9, wherein the circuit card integrated corrosion management component comprises a corrosion management layer adhered to a backplane of a circuit card.

11. The computing device of claim 1, wherein the corrosion management component is an air filter integrated corrosion management component adapted to filter gases entering a chassis that houses the computing device.

12. The computing device of claim 1, further comprising:
an environmental manager programmed to:
monitor environmental conditions associated with the computing component; and
heat, while the environmental conditions indicate that the risk of corrosion is low, the corrosion management component.

13. The computing device of claim 12, wherein the environmental conditions indicate that the risk of corrosion is low while the computing component is at an elevated temperature.

14. The computing device of claim 13, wherein heating the corrosion management component also heats the computing component.

15. The computing device of claim 14, wherein heating the corrosion management components increases the risk of corrosion.

16. The computing device of claim 15, wherein the corrosion management component is heated by one selected from a group consistent of:
generation of heat by the computing component, and
generation of heat by a heating device.

17. A method for environmentally managing a computing device of an information handling system, comprising:
monitoring environmental conditions associated with a computing component of the computing device;
while the environmental conditions indicate that a risk of corrosion of the computing component is low, increasing the risk of corrosion by heating a corrosion management component; and
while the environmental conditions indicate that the risk of corrosion is not low, decreasing the risk of corrosion by absorbing humidity using the corrosion management component.

18. The method of claim 17, wherein heating the corrosion management component expels humidity from the corrosion management component.

19. A non-transitory computer readable medium comprising computer readable program code, which when executed by a computer processor enables the computer processor to perform a method for environmentally managing a computing device of an information handling system, the method comprising:
monitoring environmental conditions associated with a computing component of the computing device;
while the environmental conditions indicate that a risk of corrosion of the computing component is low, increasing the risk of corrosion by heating a corrosion management component; and
while the environmental conditions indicate that the risk of corrosion is not low, decreasing the risk of corrosion by absorbing humidity using the corrosion management component.

20. The non-transitory computer readable medium of claim 19, wherein heating the environmental management component expels humidity from the corrosion management component.
